(19) United States
(12) Patent Application Publication
(10) Pub. No.: US 2025/0316831 A1
(43) Pub. Date: Oct. 9, 2025

(54) BATTERY PACK

(71) Applicant: SK On Co., Ltd., Seoul (KR)

(72) Inventor: Se Hyeon KIM, Daejeon (KR)

(21) Appl. No.: 19/097,875

(22) Filed: Apr. 2, 2025

(30) Foreign Application Priority Data
Apr. 3, 2024 (KR) 10-2024-0045369

(51) Int. Cl. H01M 50/358; H01M 50/209; H01M 50/271; H01M 50/383

(52) U.S. Cl. CPC H01M 50/358; H01M 50/209; H01M 50/271; H01M 50/383

(57) ABSTRACT

The present disclosure relates to a battery pack including a plurality of battery cells, a pack case forming an accommodating space accommodating the plurality of battery cells, a through-hole penetrating one surface of the pack case, a housing coupled to the one surface of the pack case, a separation panel separating an inside of the housing into a first space and a second space, an inlet hole passing through one surface of the housing forming the first space and connected to the through-hole, an outlet hole passing through an other surface of the housing forming the first space and allowing the outside to communicate with the first space, a collection hole penetrating the separation panel and allowing the first space and the second space to communicate with each other, and a door rotatably coupled to the separation panel to open and close the collection hole.

### CROSS-REFERENCE TO RELATED PATENT APPLICATION

The present application claims priority under 35 U.S.C. § 119(a) to Korean patent application number 10-2024-0045369 filed on Apr. 3, 2024, in the Korean Intellectual Property Office, the entire disclosure of which is incorporated by reference herein.

### BACKGROUND OF THE INVENTION

### 1. Field

The present disclosure relates to a battery pack, and more particularly, to a battery pack improving stability by suppressing the exposure of flames to the outside during thermal runaway of a battery cell.

### 2. Description of the Related Art

In a secondary battery (or a battery cell), when an anode and a cathode come into contact with each other due to internal short circuits, external shocks, etc., a rapid exothermic reaction may occur due to instantaneous high currents. This exothermic reaction may rapidly increase the temperature inside the battery cell. This is called thermal runaway of the battery cell. When thermal runaway occurs in the battery cell, a case (or an exterior material) of the battery cell is opened, and a high-temperature fluid generated from the inside may be discharged.

The fluid may include particles as well as flammable gases. Since the particles may act as ignition particles of the gas, a structure such as a deflector may be utilized to filter the particles in the fluid so as to suppress flames. However, as time passes after the thermal runaway occurs, the performance of filtering the particles in the deflector reaches a threshold because the filtered particles are deposited to simplify or straighten a gas path. In other words, flames may be exposed to the outside as the flammable gases are burned with the high-temperature particles. Therefore, it is necessary to separate a movement path of the fluid from a collection space of the particles separated from the fluid.

### SUMMARY OF THE INVENTION

An object of the present disclosure is to improve the stability of a battery pack even when thermal runaway of a battery cell occurs.

Another object of the present disclosure is to separate a space in which a fluid moves from a space in which particles are collected during thermal runaway of the battery cell.

Another object of the present disclosure is to reduce the amount of particles contained in the fluid when the fluid generated by the thermal runaway of the battery cell is discharged to the outside of the battery pack

Another object of the present disclosure is to reduce or prevent a flame from being exposed to the outside due to the particles mixed in the fluid after a predetermined time elapses when the fluid generated by the thermal runaway of the battery cell is discharged to the outside of the battery pack.

Another object of the present disclosure is to reduce variations in the amount of particles separated from the fluid, depending on the position of a partition wall provided in a discharge unit (or a deflector), when the fluid generated by the thermal runaway of the battery cell is discharged to the outside of the battery pack.

Another object of the present disclosure is to prevent the straightening of a discharge path when the particles mixed in the fluid generated by the thermal runaway of the battery cell are stacked on the discharge path.

Meanwhile, the present disclosure can be widely applied in the fields of electric vehicles, battery charging stations, energy storage systems (ESS), and other green technologies such as photovoltaics and wind power using batteries. In addition, the present disclosure may be used in eco-friendly mobility, including electric vehicles and hybrid vehicles, to prevent climate change by suppressing air pollution and greenhouse fluid emissions.

A battery pack according to embodiments of the present disclosure may include a plurality of battery cells, a pack case forming an accommodating space accommodating the plurality of battery cells, a through-hole penetrating one surface of the pack case, a housing coupled to the one surface of the pack case, a separation panel separating an inside of the housing into a first space and a second space, an inlet hole passing through one surface of the housing forming the first space and connected to the through-hole, an outlet hole passing through an other surface of the housing forming the first space and allowing the outside to communicate with the first space, a collection hole penetrating the separation panel and allowing the first space and the second space to communicate with each other, and a door rotatably coupled to the separation panel to open and close the collection hole.

The one surface of the housing and the other surface of the housing may oppose each other.

The housing may include a first side surface and a second side surface forming both side surfaces of the housing in a direction away from the one surface of the pack case, the inlet hole may be located close to one of the first and second side surfaces, and the outlet hole may be located close to an other side surface.

The battery pack may further include a partition wall extending from one of the one surface of the housing and the other surface of the housing toward an other, the partition wall spaced apart from the other.

The partition wall may change a flow direction of a fluid containing particles generated in one or more of the plurality of battery cells when the fluid is introduced through the inlet hole and moves toward the outlet hole.

The partition wall may include a plurality of partition walls, and the plurality of partition walls may include a first partition wall protruding from the other surface of the housing, and a second partition wall protruding from the one surface of the housing.

The partition wall may be provided as a plurality of partition walls, and the collection hole and the door may be provided between the plurality of partition walls and between the plurality of partition walls and the housing, respectively.

The door may rotate towards the second space and be opened.

The battery pack may further include a hinge portion rotatably coupling the door to the separation panel, and the hinge portion may be located at a perimeter of the collection hole.

The door may be opened and closed based on a weight of the particles separated from a fluid containing particles generated in one or more of the plurality of battery cells in the first space and stacked on the door.

The battery pack may further include a hinge portion rotatably coupling the door to the separation panel, wherein the hinge portion opens the door to be inclined downward toward the second space in a direction opposite to a direction in which the fluid moves.

The battery pack may further include a protective cover coupled to the housing to cover the outlet hole.

The protective cover may be separated from the outlet hole when pressure in the accommodating space reaches a predetermined allowable pressure.

A material of the protective cover and a material of the housing may be different from each other. A volume of the first space may be greater than a volume of the second space.

The inlet hole may include a first inlet hole and a second inlet hole penetrating the one surface of the housing, and the outlet hole may be located between the first inlet hole and the second inlet hole.

A battery pack according to embodiments of the present disclosure may include a plurality of battery cells, a pack case forming an accommodating space accommodating the plurality of battery cells, and a discharge unit including a housing coupled to the pack case and including a first space communicating with the accommodating space and a second space separated from the first space by a separation panel, wherein the first space and the second space selectively communicate with each other by a door rotatably coupled to the separation panel and opening and closing a collection hole passing through the separation panel.

The discharge unit may be provided as a plurality of discharge units.

The plurality of discharge units may include a first discharge unit and a second discharge unit coupled next to each other to one surface of the pack case, and inlet holes of the first discharge unit and the second discharge unit may be located between outlet holes of the first discharge unit and the second discharge unit.

### BRIEF DESCRIPTION OF THE DRAWINGS

FIG. 1 shows an example of a battery pack according to the present disclosure.

FIG. 2 shows an example of a battery pack according to the present disclosure as viewed from above.

FIG. 3 shows a cross-section of a discharge unit as viewed from above.

FIG. 4 shows a cross-section of a discharge unit as viewed from the front.

FIG. 5 shows another example of a battery pack according to the present disclosure.

FIG. 6 shows another example of a battery pack according to the present disclosure.

### DETAILED DESCRIPTION

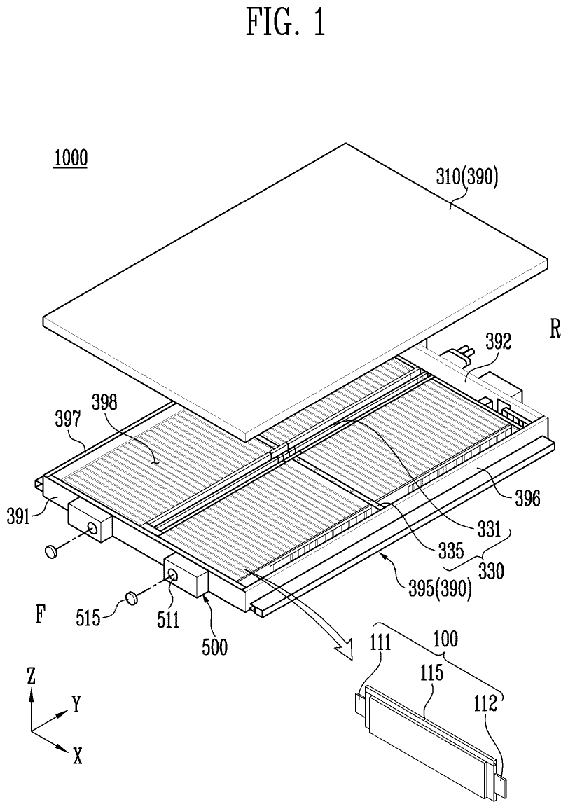

Hereinafter, the present disclosure will be described in detail with reference to the accompanying drawings. This is, however, illustrative only and is not intended to limit the disclosure to the specific embodiments illustratively described. In the present disclosure, a battery, a secondary battery, and a cell all refer to a battery cell which can be charged and discharged. FIG. 1 shows an example of a battery pack 1000 according to the present disclosure.

Referring to FIG. 1, the battery pack 1000 according to the present disclosure may include a plurality of battery cells 100, a pack case 390 accommodating the plurality of battery cells 100, and a discharge unit 500 coupled to one surface of the pack case 390 so as to communicate with the inside of the pack case 390.

The battery cell 100 may include a main body portion 115 including an electrode assembly (not shown) which produces or stores electrical energy therein, and lead tab portions 111 and 112 which are electrically connected to the electrode assembly and protrude to the outside of the main body portion 115.

Referring to FIG. 1, the battery cell 100 is a pouch-shaped battery cell, but the battery cell 100 in this specification is not limited to the pouch-shaped battery cells 100. That is, the battery pack 1000 according to the present disclosure may include the battery cell 100 having a prismatic or cylindrical shape.

Referring to FIG. 1, the battery pack 1000 according to the present disclosure may accommodate the plurality of battery cells 100 in an accommodating space 398. The plurality of battery cells 100 may be stacked in a predetermined stacking direction.

FIG. 1 shows an example in which the plurality of battery cells 100 are stacked in a Y direction. However, the plurality of battery cell 100 may also be stacked in other directions.

The pack case 390 may include an accommodating cover 310 and an accommodating body 395 which together form the accommodating space 398. Referring to FIG. 1, one surface of the accommodating body 395 may be opened. The accommodating cover 310 may be coupled to the accommodating body 395 to cover the opened surface.

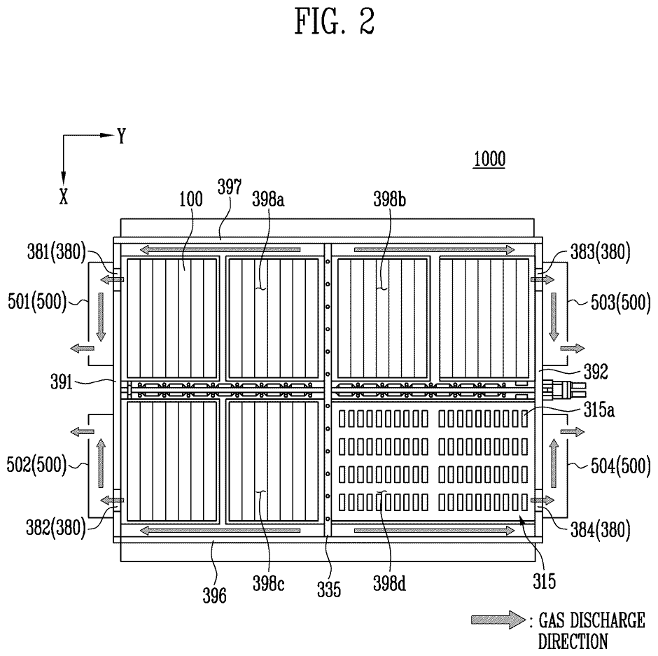

In addition, the pack case 390 may include a partitioning unit 330 for partitioning the accommodating space 398 into a plurality of sub-spaces 398a to 398d (see FIG. 2). The partitioning unit 330 may include a first frame 331 extending in the Y direction and a second frame 335 extending in an X direction in the accommodating space 398.

That is, the partitioning unit 330 may partition the accommodating space 398 into the plurality of sub-spaces 398a to 398d in two directions which are perpendicular to a height direction of the pack case 390 and perpendicular to each other.

FIG. 1 shows an example in which the plurality of battery cells 100 are grouped into a predetermined number and arranged in two columns in the Y direction. In addition, the plurality of battery cells 100 may be arranged in two rows in the X direction. This is only an example, and the number of sub-spaces 398a to 398d may vary, and accordingly, the numbers of rows and columns may be changed.

The pack case 390 may include a bottom surface supporting the plurality of battery cells 100, and pack side surfaces 391, 392, 396, and 397 extending from respective corners of the bottom surface toward the accommodating cover 310 to form side surfaces of the pack case 390.

In this specification, one surface of the pack case 390 may refer to one of the pack side surface, the bottom surface, and the accommodating cover 310.

In this specification, a front F and a rear R are defined only to facilitate explanation and understanding. The front and rear of the battery pack 1000 according to the present disclosure are not limited to the front F and the rear R shown in the drawings.

The battery pack 1000 according to the present disclosure may include the discharge unit 500 which is communicatively coupled to the pack case 390.

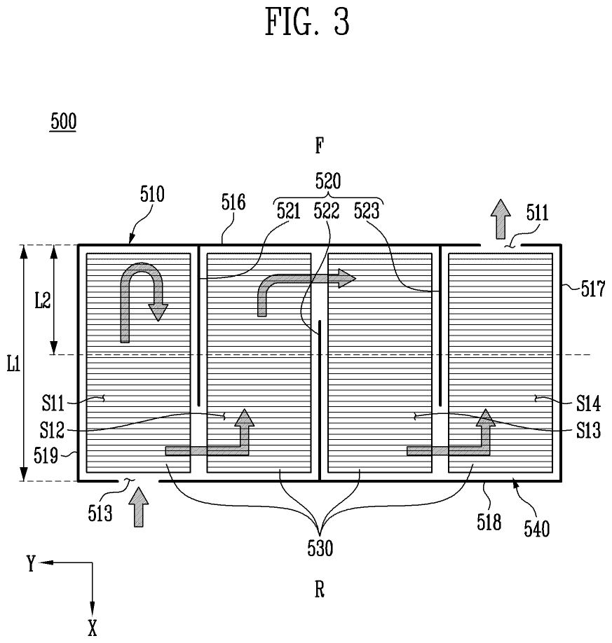

The discharge unit 500 may include a housing 510 (see FIG. 3) which forms an outer shape of the discharge unit 500, an inlet hole 513 (see FIG. 2) which is formed through one surface of the housing 510, and an outlet hole 511 which is formed through another surface of the housing 510.

The discharge unit 500 may further include a protective cover 515 coupled to the housing 510 and covering the outlet hole 511.

The protective cover 515 may be separated from the outlet hole 511 when the pressure in the accommodating space 398 reaches a predetermined allowable pressure.

When the anode and the cathode come into unintentional contact with each other in the battery cell 100, the temperature inside the battery cell 100 rapidly increases, and thermal runaway may occur. As a result, when the battery cell 100 expands, the case of the battery cell 100 may be opened or torn, and the fluid and flame therein may be discharged into the accommodating space 398.

The term “fluid” as used herein refers to a concept which includes both a gas generated directly or indirectly by thermal runaway of a battery cell, a liquid substance mixed with the gas, and a colloidal substance. The fluid may also include particles in solid form due to high temperature. Unless particles are specifically excluded, “fluid” or “fluid containing particles” both mean that particles are contained in the fluid. Thus, the particles may also move together in the direction of movement of the fluid.

When the thermal runaway of the battery cell 100 starts to propagate to adjacent battery cells 100, the temperature and pressure of the accommodating space 398 may increase. Considering the safety of the user, the fluid in the accommodating space 398 generated by the thermal runaway may be quickly discharged to the outside. To this end, the protective cover 515 may be torn or exploded when the pressure in the accommodating space 398 is greater than or equal to the allowable pressure. That is, the protective cover 515 is separated from the housing 510 at the allowable pressure or higher and may allow the accommodating space 398 to communicate with the outside through the discharge unit 500. Therefore, the fluid in the accommodating space 398 may be discharged to the outside through the discharge unit 500. The material of the protective cover 515 may be different from the material of the housing

510 in order for the protective cover 555 to be separated from the housing 510 at the allowable pressure or higher. For example, the protective cover 515 may include a polymer material, while the housing 510 may include metal.

FIG. 2 shows an example of the battery pack 1000 according to the present disclosure as viewed from above.

Referring to FIG. 2, the plurality of battery cells 100 may be accommodated in the plurality of sub-spaces 398a to 398d. Referring to FIG. 2, the battery pack 1000 may include a sub-cover 315 which covers each of the sub-spaces 398a to 398d.

The sub-cover 315 may further include a plurality of sub-cover through-holes 315a passing through the sub-cover 315.

The pack case 390 may include a through-hole 380 penetrating one surface of the pack case 380.

Referring to FIG. 2, the through-hole 380 may include a plurality of through-holes 381 to 384 provided in one surface of the pack case 390. The plurality of through-holes 381 to 384 are for quickly discharging the fluid filling the accommodating space 398 to the outside.

The plurality of through-holes 381 to 384 may be located in the sub-spaces 398a to 398d, respectively. This is to efficiently discharge fluid regardless of the position of the sub-spaces 398a to 398d.

However, this is merely an example, and the number of through-holes 380 may vary depending on the number of sub-spaces 398a to 398d.

Referring to FIG. 2, the fluid generated in one of the battery cells 100 may move toward the pack side surface 396 or 397 in the X direction. Since a busbar electrically connecting the plurality of battery cells 100 to the outside is located at the center of the battery pack 1000, the space through which the fluid passes may be relatively small.

That is, the fluid generated in one of the battery cells 100 may move in the X direction to the pack side surface 396 or 397 of the battery pack 1000, and may then move toward the discharge unit 500 or another pack side surface 391 or 392 located in front of and behind the battery pack 1000 in a direction parallel to the pack side surface 396 or 377.

On the pack side surface 396 or 397, the fluid may move through an empty space between the pack side surface 395 or 397 and the plurality of battery cells 100. In contrast, the battery pack 1000 may further include a tunnel-shaped frame (not shown) so that the fluid may move inside on the pack side surface 396 or 397.

The fluid reaching close to the discharge unit 500 in the accommodating space 398 may enter the discharge unit 500 through the through-hole 380 and the inlet hole 513 which faces and connects the through-hole 380.

As mentioned above, the fluid may include particles. The discharge unit 500 may separate or filter the particles from the fluid to reduce the amount of particles contained in the fluid, and may then discharge the fluid to the outside through the outlet hole 511.

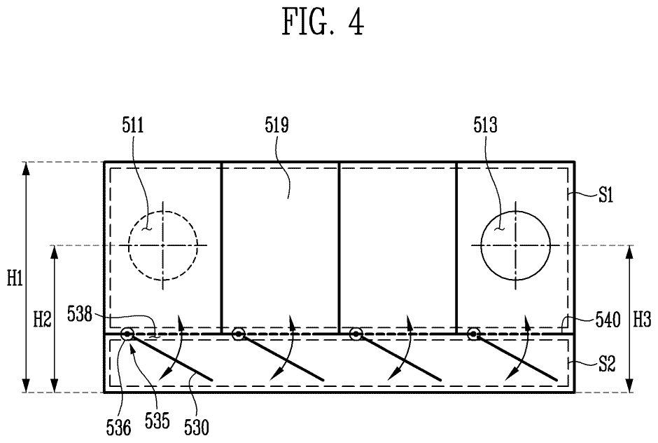

FIG. 3 shows a cross-section of the discharge unit 500 as viewed from above. FIG. 4 shows a cross-section of the discharge unit 500 as viewed from the front.

Referring to FIGS. 3 and 4, the discharge unit 500 may include the housing 510 coupled to the one surface of the pack case 390, a separation panel 540 which separates the inside of the housing 510 into a first space S1 and a second space S2, the inlet hole 513 which passes through the one surface of the housing 510 forming the first space S1 to communicate with the through-hole 380, the outlet hole 511 which passes through the other surface of the housing 510 forming the second space S2 to connect the outside to the first space S1, a collection hole 538 which passes through the separation panel 540 to connect the first space S2 to the second space S2, and a door 530 which is rotatably coupled to the separation panel 540 to open and close the collection hole 538.

The housing 510 may form an outer shape of the discharge unit 500. The housing 510 may include a contact surface 518 which is one surface of the housing 510 coupled to the pack case 390, and an opposing surface 516 which is the other surface of the housing 510 which opposes the contact surface 518.

The contact surface 518 may include the inlet hole 513 connected to the through-hole 380.

When the housing 510 is coupled to the pack case 390, the through-hole 380 and the inlet hole 513 may be connected at the same position so that the accommodating space 398 and the first space S1 may communicate with each other.

The opposing surface 516 may include the outlet hole 511 which communicates with the first space S1.

Referring to FIG. 3, the opposing surface 516 may be closer to the front F of the battery pack 1000 than the contact surface 518, and the opposing surface 516 may be closer to the rear R of the battery pack 1000 than the contact surface 518. At least a portion of the contact surface 518 may be located closer to one surface of the pack case 390 than the opposing surface 516.

The housing 510 may include a first side surface 519 and a second side surface 517 which connect the contact surface 518 and the opposing surface 516 in a direction away from one surface of the pack case 390.

The housing 510 may include the separation panel 540 extending on one surface of the pack case 390 to separate the inside of the housing 510 into the first space S1 and the second space S2.

Referring to FIG. 4, the separation panel 540 may be located in the housing 510 to form a bottom surface of the first space S1 which is an upper surface of the second space S2. Referring to FIGS. 3 and 4, the first space S1 may communicate with the accommodating

space 398 and the outside through the inlet hole 513 and the outlet hole 511. In this manner, the fluid (including the particles) generated by thermal runaway in one of the battery cells 100 may move from the accommodating space 398 to the first space S1 through the through-hole 380 and the inlet hole 513 connected to the through-hole 380. Subsequently, the fluid may be discharged to the outside from the first space S1 through the outlet hole 511.

The second space S2 may be for capturing particles separated by their own weight when the fluid moves through the first space S1. The second space S2 may selectively communicate with the first space S1 through the separation panel 540.

The inlet hole 513 may be included in one surface of the housing 510. For example, referring to FIG. 3, the inlet hole 513 may be located on the contact surface 518. In addition, the inlet hole 513 may be located close to one of the first side surface 519 and the second side surface 517.

The outlet hole 511 may be included in other surface of the housing 510. For example, referring to FIG. 3, the outlet hole 511 may be located on the opposing surface 516. The outlet hole 511 may be located close to the other of the first side surface 519 and the second side surface 517.

The inlet hole 513 and the outlet hole 511 may be preferably spaced apart from each other as much as possible. In this manner, particles may be separated or filtered from the fluid as much as possible while the fluid passes through the first space S1.

Referring to FIG. 4, a height H2 of the inlet hole 513 and a height H3 of the outlet hole 511 may be different from each other because the amount of particles contained in the fluid flowing in through the inlet hole 513 and the temperature of the fluid are different from the amount of particles included in the fluid discharged through the outlet hole 511 and the temperature of the fluid.

Referring to FIG. 4, the volume of the first space S1 may be larger than the volume of the second space S2. The first space S1 serves as a passage through which the fluid moves, while the second space S2 is a space in which solid particles are collected and stored.

Therefore, referring to FIG. 4, the height H3 of the inlet hole 513 and the height H2 of the outlet hole 511 may be at least half the height H1 of the housing 510.

Referring to FIG. 3, the discharge unit 500 may further include a partition wall 520 which extends from one of the one surface of the housing 510 and the other surface of the housing 510 toward the other, and an extended end portion of the partition wall 520 is disposed to be spaced apart from the other.

A length of the partition wall 520 may be less than a distance between the one surface of the housing 510 and the other surface of the housing 510, and may be more than half of a distance between one surface and another surface of the housing 510.

For example, referring to FIG. 3, a length to which the partition wall 520 protrudes may be less than a distance L1 between the contact surface 518 and the opposing surface 516, and may be more than half of a distance L2 between the contact surface 518 and the opposing surface 516.

The partition wall 520 is for extending the distance to which the fluid moves in the first space S1 by changing the direction of fluid movement, so that enough time for the particles to separate from the fluid may be ensured.

That is, the fluid which enters through the inlet hole 513 may not move diagonally toward the outlet hole 511 but may move in a zigzag pattern by the partition wall 520. While the fluid moves in the zigzag pattern by the partition wall 520, the particles contained in the fluid and moving together may fall toward the separation panel 540 by their own weight. That is, the particles may be stacked on the separation panel 540.

The partition wall 520 may be provided as a plurality of partition walls 520 to extend the moving distance of the fluid. The plurality of partition walls 520 may include a first partition wall 521 protruding from the other surface of the housing 510 and a second partition wall 522 protruding from the one surface of the housing 510.

In addition, the plurality of partition walls 520 may be provided next to each other. However, this is only an example. The plurality of partition wall 520 may not be arranged next to each other as long as the plurality of partitions 520 ensure enough time to separate the particles from the fluid.

The first partition wall 521 may protrude from the opposing surface 516 toward the contact surface 518, and the second partition wall 522 may protrude from the contact surface 518 toward the opposing surface 516.

Although FIG. 3 shows the discharge unit 500 including two first partition walls 521 and 523 and one second partition wall 522, the number of partition walls 520 may vary.

The fluid introduced through the inlet hole 513 may move toward the opposing surface 516. The fluid diverted from the opposing surface 516 may then move in the first partition 521 towards the contact surface 518. The fluid may then move into a gap between the end of the first partition 521 and the contact surface 518 and move towards the outlet hole 511 in the movement path having the zigzag pattern as described above.

The first space S1 may be partitioned into a plurality of partition spaces S11 to S14 by the first side surface 519, the second side surface 517, and the plurality of partition walls 520.

That is, the plurality of partition spaces S11 to S14 may be formed between the plurality of partition walls 520 or between the plurality of partition walls 520 and the housing 510.

For example, FIG. 3 shows the four partition spaces S11 to S14 divided by the three partition walls 521, 522, and 523, the first side surface 519, and the second side surface 517.

Referring to FIGS. 3 and 4, the discharge unit 500 may include the collection hole 538 penetrating the separation panel 540 and the door 530 rotatably coupled to the separation panel 540 to open and close the collection hole 538.

The first space S1 and the second space S2 may communicate with each other through the collection hole 538. When the first space S1 and the second space S2 communicate with each other at all times, unnecessary secondary flow may occur in the flow of the fluid. Thus, in a general situation, the second space S2 is in a closed state, and it is necessary to make the second space S3 opened through the collection hole 538 only in necessary situations.

To this end, the discharge unit 500 may include the door 530 which is rotatably coupled to the separation panel 540 to open and close the collection hole 538.

Referring to FIG. 4, the door 530 may be opened while rotating toward the second space S2.

The door 530 may be opened and closed based on the weight of the particles which are separated from the fluid in the first space S1 and stacked on the door 530 from the fluid including particles generated in one or more battery cells 100 among the plurality of battery cells 100.

That is, when the weight of the particles stacked on the door 530 is greater than or equal to a predetermined rotation weight, the door 530 may rotate toward the second space S2 to open the collection hole 538.

To this end, the door 530 may further include a hinge portion 535 located around the

collection hole 538 to rotatably couple the door 530 to the separation panel 540. In addition, the hinge portion 535 may be located around the collection hole 538.

The hinge portion 535 may open the door 530 so as to be inclined downward toward the second space S2 in a direction opposite to the direction in which the fluid moves.

When the door 530 is inclined downward toward the second space S2 in the direction in which the fluid moves, the door 530 may be opened by the movement of the fluid.

Therefore, when the collection hole 538 has a rectangular shape, the hinge portion 535 may be positioned around the collection hole 535 in a direction perpendicular to the direction from the first side surface 519 toward the second side surface 517.

A hinge shaft 536 of the hinge portion 535 may be positioned in parallel with the partition wall 520 around the collection hole 538.

As the time elapses after thermal runaway occurs in one battery cell 100, the amount of particles separated as the fluid passes through the first space S1 may increase. Therefore, when a predetermined threshold time passes, the movement path of the fluid is reduced and straightened due to the stacked particles, so that the particles may not be separated and may be discharged together with the fluid through the outlet hole 511. To avoid the non-separation of the particles, the battery pack 1000 according to the present disclosure separates a space in which the fluid moves and the collection space in which the particles separated from the fluid are collected.

When the weight of the particles stacked on the door 530 is greater than or equal to the rotation weight, the door 530 may rotate toward the second space S2, and the second space S2 may be opened. The particles stacked on the door 530 may move to the second space S2 and may be collected in the door 530. When the particles stacked on the door 530 move to the second space S2, the door 530 may rotate to close the collection hole 538. To this end, the door 530 may further include an elastic member (not shown) connected to the hinge shaft 536.

The discharge unit 500 may include a plurality of collection holes 538 penetrating the separation panel 540. The plurality of collection holes 538 may be located below the partition spaces S11 to S14, respectively. In addition, the discharge unit 500 may include a plurality of doors 530 for opening and closing the plurality of collection holes 538, respectively.

That is, the collection holes 538 and the doors 530 may be provided between the plurality of partition walls 520 and between the plurality of partition walls 520 and the housing 510, respectively.

Referring to FIGS. 1 to 4, the battery pack 1000 according to the present disclosure may include the plurality of battery cells 100, the pack case 390 forming the accommodating space 398 accommodating the plurality of battery cells 10, and the discharge unit 500 coupled to the pack case 390 and including the first space S1 communicating with the accommodating space 398 and the second space S2 separated from the first space S1 by the separation panel 540.

The first space S1 and the second space S2 may selectively communicate with each other by the door 530 which is rotatably coupled to the separation panel and opens and closes the collection hole 538 passing through the separation panel 540.

Further, referring to FIGS. 2 and 4, the discharge unit 500 may be provided as a plurality of discharge units 500. The pack case 390 may include the through-holes 381 to 384 connected to the inlet hole 513 of each discharge unit 500.

Referring to FIGS. 2 and 4, the battery pack 1000 may include a first through-hole 381 and a second through-hole 382 penetrating one surface of the pack case 390.

In addition, each of the plurality of discharge units 500 may include a first discharge unit 501 communicating with the accommodating space 398 through the first through-hole 381 and a second discharge unit 502 communicating with the accommodating space 398 through the second through-hole 382.

Considering the moving direction of the fluid, the inlet holes 513 of the first discharge unit 501 and the second discharge unit 502 may be located between the outlet holes 511 of the first discharge unit 501 and the second discharge unit 502.

The battery pack 1000 may include a third through-hole 383 and a fourth through-hole 384 penetrating the other surface of the pack case 390 facing one surface of the pack case 390. In addition, each of the plurality of discharge units 500 may include a third discharge unit 503 communicating with the accommodating space 398 through the third through-hole 383 and a fourth discharge unit 504 communicating with the accommodating space 398 through the fourth through-hole 384.

The functions and structures of the third discharge unit 503 and the fourth discharge unit 504 are the same as those of the first discharge unit 501 and the second discharge unit 502. Thus, descriptions thereof are omitted.

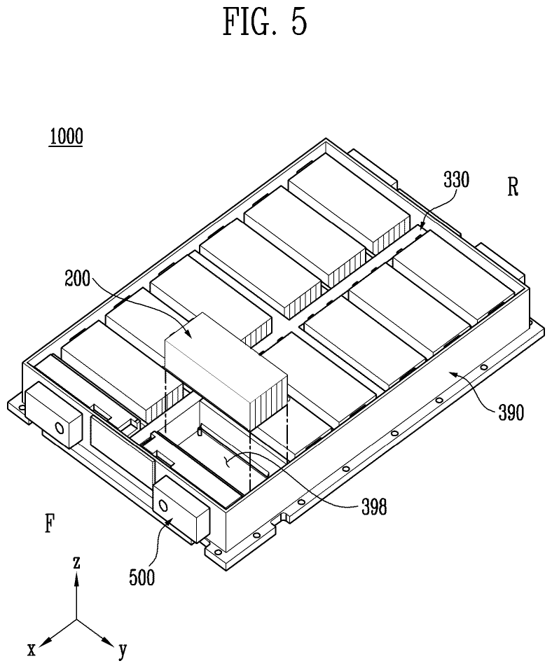

FIG. 5 shows another example of the battery pack 1000 according to the present disclosure.

Referring to FIG. 5, the battery pack 1000 according to another example of the present disclosure may include a battery module 200 including battery cells 100 grouped into a predetermined number, and may accommodate the battery module 200 in the accommodating space 398. The accommodating space 398 may be partitioned into a plurality of sub-spaces by the partitioning unit 330.

Similarly, the battery pack 1000 according to another example of the present disclosure may include the pack case 390 including the accommodating cover 310 (see FIG. 1) and the accommodating body 395, and the discharge unit 500 communicatively coupled to the pack case 390.

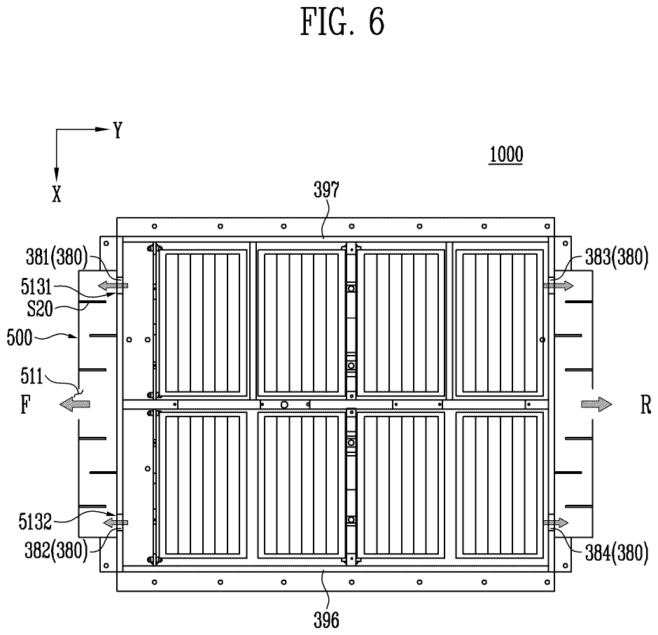

FIG. 6 shows another example of the battery pack 1000 according to the present disclosure.

Unlike FIG. 2, FIG. 6 shows an example in which the plurality of through-holes 380 formed in one surface of the pack case 390 are connected to one discharge unit 500.

To this end, the inlet hole 513 may include a first inlet hole 5131 and a second inlet hole 5132 penetrating the one surface of the housing 510, and the outlet hole 511 may be located between the first inlet hole 5131 and the second inlet hole 5132.

The amount of fluid flowing into the first inlet hole 5131 due to the pressure difference between the accommodating space 398, the first space S1, and the outside is discharged through the second inlet hole 5132 instead of the outlet hole 511 may be ignored.

According to an embodiment of the present disclosure, the stability of a battery pack may be improved even when thermal runaway of a battery cell occurs.

According to another aspect of the present disclosure, it is possible to separate a space in which a fluid moves from a space in which particles are collected during thermal runaway of the battery cell.

According to another embodiment of the present disclosure, when the fluid generated by the thermal runaway of the battery cell is discharged to the outside of the battery pack, the amount of particles contained in the fluid may be reduced.

According to another embodiment of the present disclosure, when the fluid generated by the thermal runaway of the battery cell is discharged to the outside of the battery pack, it is possible to reduce or prevent a flame from being exposed to the outside due to the particles mixed in the fluid after a predetermined time elapses.

According to another embodiment of the present disclosure, when the fluid generated by the thermal runaway of the battery cell is discharged to the outside of the battery pack, it is possible to reduce variations in the amount of particles separated from the fluid, depending on the position of a partition wall provided in a discharge unit (or a deflector).

According to another aspect embodiment of the present disclosure, the straightening of a discharge path may be prevented when the particles mixed in the fluid generated by the thermal runaway of the battery cell are stacked on the discharge path, thereby improving filtering performance.

The present disclosure may be modified and implemented in various forms, and its scope is not limited to the above-described embodiments. The content described above is merely an example of applying the principles of the present disclosure, and other features may be further included without departing from the scope of embodiments according to the present disclosure.

What is claimed is:

1. A battery pack comprising:
a plurality of battery cells;
a pack case forming an accommodating space accommodating the plurality of battery cells;
a through-hole penetrating one surface of the pack case;
a housing coupled to the one surface of the pack case;
a separation panel separating an inside of the housing into a first space and a second space;
an inlet hole passing through one surface of the housing forming the first space and connected to the through-hole;
an outlet hole passing through an other surface of the housing forming the first space and allowing the outside to communicate with the first space;
a collection hole penetrating the separation panel and allowing the first space and the second space to communicate with each other; and
a door rotatably coupled to the separation panel to open and close the collection hole.

2. The battery pack according to claim 1, wherein the one surface of the housing and the other surface of the housing oppose each other.

3. The battery pack according to claim 1, wherein the housing comprises a first side surface and a second side surface forming both side surfaces of the housing in a direction away from the one surface of the pack case,
wherein the inlet hole is located close to one of the first and second side surfaces, and
wherein the outlet hole is located close to an other side surface.

4. The battery pack according to claim 1, further comprising a partition wall extending from one of the one surface of the housing and the other surface of the housing toward an other, the partition wall spaced apart from the other.

5. The battery pack according to claim 4, wherein the partition wall changes a flow direction of a fluid containing particles generated in one or more of the plurality of battery cells when the fluid is introduced through the inlet hole and moves toward the outlet hole.

6. The battery pack according to claim 4, wherein the partition wall comprises a plurality of partition walls, and
wherein the plurality of partition walls comprise:
a first partition wall protruding from the other surface of the housing; and
a second partition wall protruding from the one surface of the housing.

7. The battery pack according to claim 4, wherein the partition wall is provided as a plurality of partition walls, and
wherein the collection hole and the door are provided between the plurality of partition walls and between the plurality of partition walls and the housing, respectively.

8. The battery pack according to claim 1, wherein the door rotates towards the second space and is opened.

9. The battery pack according to claim 1, further comprising a hinge portion rotatably coupling the door to the separation panel, and
wherein the hinge portion is located at a perimeter of the collection hole.

10. The battery pack according to claim 1, wherein the door is opened and closed based on a weight of the particles separated from a fluid containing particles generated in one or more of the plurality of battery cells in the first space and stacked on the door.

11. The battery pack according to claim 10, further comprising a hinge portion rotatably coupling the door to the separation panel,
wherein the hinge portion opens the door to be inclined downward toward the second space in a direction opposite to a direction in which the fluid moves.

12. The battery pack according to claim 1, further comprising a protective cover coupled to the housing to cover the outlet hole.

13. The battery pack according to claim 12, wherein the protective cover is separated from the outlet hole when pressure in the accommodating space reaches a predetermined allowable pressure.

14. The battery pack according to claim 12, wherein a material of the protective cover and a material of the housing are different from each other.

15. The battery pack according to claim 1, wherein a volume of the first space is greater than a volume of the second space.

16. The battery pack according to claim 1, wherein the inlet hole includes a first inlet hole and a second inlet hole penetrating the one surface of the housing, and
wherein the outlet hole is located between the first inlet hole and the second inlet hole.

17. A battery pack comprising:
a plurality of battery cells;
a pack case forming an accommodating space accommodating the plurality of battery cells; and
a discharge unit including a housing coupled to the pack case and including a first space communicating with the accommodating space and a second space separated from the first space by a separation panel,
wherein the first space and the second space selectively communicate with each other by a door rotatably coupled to the separation panel and opening and closing a collection hole passing through the separation panel.

18. The battery pack according to claim 17, wherein the discharge unit is provided as a plurality of discharge units.

19. The battery pack according to claim 18, wherein the plurality of discharge units comprise a first discharge unit and a second discharge unit coupled next to each other to one surface of the pack case, and
wherein inlet holes of the first discharge unit and the second discharge unit are located 5 between outlet holes of the first discharge unit and the second discharge unit.
